(19) United States
(12) Patent Application Publication
(10) Pub. No.: US 2006/0028043 A1
(43) Pub. Date: Feb. 9, 2006

(54) Compartment in an automobile for storing an umbrella

(76) Inventor: Robert Marc Zeidman, Cupertino, CA (US)

Correspondence Address: Robert M. Zeidman, 15565 Swiss Creek Lane, Cupertino, CA, 95014-5452, US

(21) Appl. No.: 10/914,070

(22) Filed: Aug. 9, 2004

(51) Int. Cl. B60R 7/04

(52) U.S. Cl. 296/37.13

(57) ABSTRACT

A compartment within an automobile doorframe for holding an umbrella that makes storage and retrieval of the umbrella convenient, prevents the automobile passenger from getting wet after getting into or out of the automobile in the rain, does not require the passenger to twist or turn in an uncomfortable manner, and is easy and inexpensive to manufacture.

### BACKGROUND OF THE INVENTION

1. Field of the Invention

The present invention relates to automobiles and umbrellas.

2. Discussion of the Related Art

When entering an automobile with an umbrella in rainy weather, one major inconvenience is closing the umbrella and placing it inside the car. If there is room, it can be placed next to the seat just inside the car door, but the water on the umbrella then drips onto the floor, getting the carpet wet and potentially causing the frame underneath to rust. Pulling the umbrella into the car and placing it in the adjacent seat or in the back requires the user to pass the umbrella over himself, getting him and his clothes wet.

When exiting an automobile with an umbrella in rainy weather, another major inconvenience is finding the umbrella within the car. If it is found, retrieving it can cause the user to twist and turn in difficult, sometimes painful ways. If the umbrella is wet, drawing it over his body will get the user and his clothes wet.

FIG. 1 depicts a prior art means for storing an umbrella in an automobile using a compartment in the automobile dashboard. An automobile 10 is provided with a dashboard 11 near the front of the passenger compartment, extending from one side of the automobile 10 to the other, beneath the windshield. A glove box or compartment 12 is conventionally provided in the dashboard 11, having a closeable and lockable door 13 which is hinged to conceal and bar access. In accordance with the prior art, a storage tube device 15 is provided in the dashboard 11 of the automobile 10 for holding a collapsible umbrella. Storage tube 15 has dimensions sufficient to loosely but closely enclose the umbrella in its collapsed configuration. To dispose of water collected from the umbrella, water disposal means are provided consisting of a discharge conduit, not shown, that carries the water collected to drain within the engine compartment of the automobile 10.

A disadvantage of this prior art invention is that it still requires the user to bring the wet umbrella over his body to place it in the compartment. Placing the umbrella in the dashboard compartment can still require the user to twist and turn in uncomfortable ways, especially if the user is in the driver's seat. If the user is a passenger in the back of the car, placing the umbrella in a dashboard compartment is not possible. A better solution is needed.

FIG. 2 depicts another prior art means for storing an umbrella in an automobile 10 using a cylindrical casing 22 located between the inner and outer panels of a rear fender 21. The umbrella container 22 is provided in an automobile 10 having a rear fender 21. The rear fender 21 is constructed of inner and outer panels between which a space is formed. The umbrella container 22 is comprised of casing within these panels. A drain hose 23 is connected to umbrella container 22 and has a lower end opened below the rear fender 21.

A disadvantage of this prior art invention is that it requires the user to twist backwards in order to insert the umbrella into the casing after the user has entered the automobile. Also, this invention does not work for the driver or the front passenger in a four-door car since the casing would be too far back for these users to reach.

FIG. 3 depicts another prior art means for storing an umbrella in an automobile 10 using a container 31 under the passenger seat 32. The umbrella holder 31 comprises a casing with a length slightly greater than a length of the umbrella to be stored. The umbrella holder 31 may be mounted within a vehicle beneath the seat 32 as illustrated in FIG. 3 or in any other position within the vehicle, such as underneath the dashboard 33, or along the door 30. Should the umbrella be wet prior to placement within the holder 31, ventilation apertures in the sides of the holder 31 permit evaporation of fluids from the umbrella.

This prior art invention is not practical since it interferes with tracks that the automobile seat sits on for adjusting the seat forward and backward. In addition, the compartment has holes to vent the rainwater out into the car. In a strong rain, the water on the umbrella will be too great to simply vent but will collect in the bottom of the container and possibly overflow it, ruining the automobile carpet and leading to rusting of the chassis. The water that does escape through ventilation will increase the humidity inside the automobile, making it uncomfortable and steaming up the windows, causing a driving hazard. Placing an umbrella in the container can cause the user to twist and turn painfully, depending upon where the container is placed within the automobile.

FIG. 4 depicts another prior art means for storing an umbrella in an automobile 10 using a holder 41 in a compartment 40 on a hinge 42 that swings out from the automobile door 30. A hollow area is formed between the outer wall and the inner panel of the vehicle door 30 of automobile 10. Arranged in the lower region of the hollow area is the receiving compartment 40 that extends substantially over the length of the vehicle door 30. The umbrella holder 41 is mounted in the receiving compartment 40 to rotate on a hinge 42.

A problem with this prior art invention is that the automobile may be parked next to another automobile, not allowing enough room for the compartment to swing out. Also, this invention adds complexity to the manufacture of the automobile door, requiring a compartment, a hinge, and a latch that must be positioned in the door in such a way that it does not interfere with electrical cables inside the door, the door handle, the window in the door, and the mechanism for rolling the window up and down.

### SUMMARY OF THE INVENTION

The present invention consists of a compartment in the automobile door frame that can hold the umbrella so that the user does not need to twist and turn, it is easy to load and unload the umbrella from the compartment, and the user does not pass the umbrella over himself and thus does not get himself wet. The present invention can be easily manufactured in today's automobiles with very few additional parts and little extra cost.

### BRIEF DESCRIPTION OF THE DRAWINGS

FIG. 1 illustrates an umbrella compartment located within the dashboard of an automobile.

FIG. 2 illustrates cylindrical container for an umbrella located between the inner and outer panels of the rear fender of an automobile.

FIG. 3 illustrates an umbrella compartment underneath the seat of an automobile.

FIG. 4 illustrates an umbrella compartment in a pivoting compartment within an automobile door.

FIG. 5 illustrates an umbrella compartment in the bottom of the doorframe of an automobile, shown from the outside of the automobile with the door closed.

FIG. 6 illustrates an umbrella compartment in the bottom of the doorframe of an automobile, shown with the automobile door open.

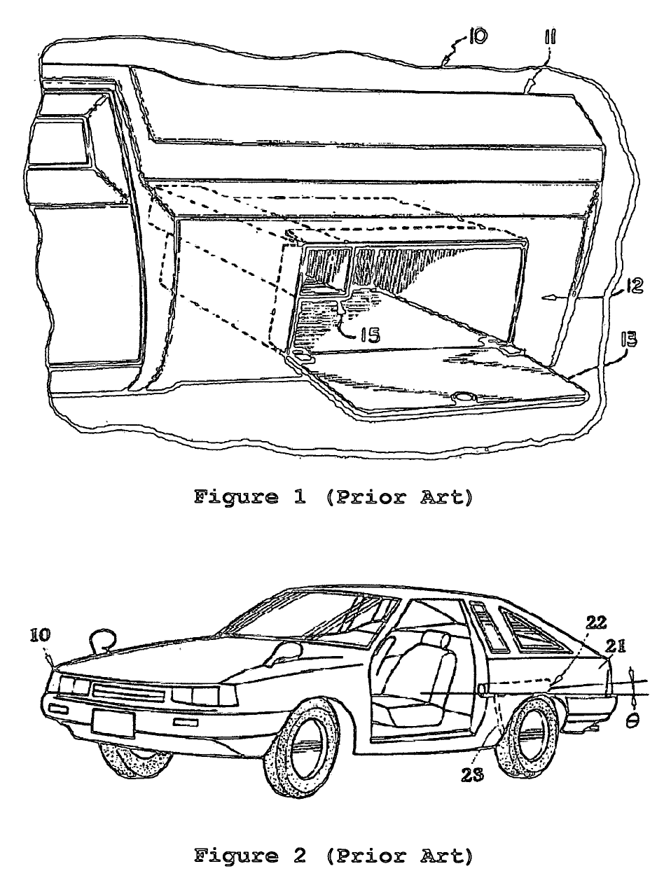

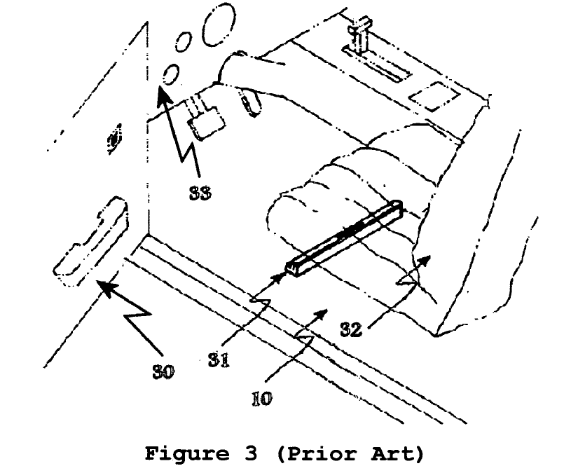

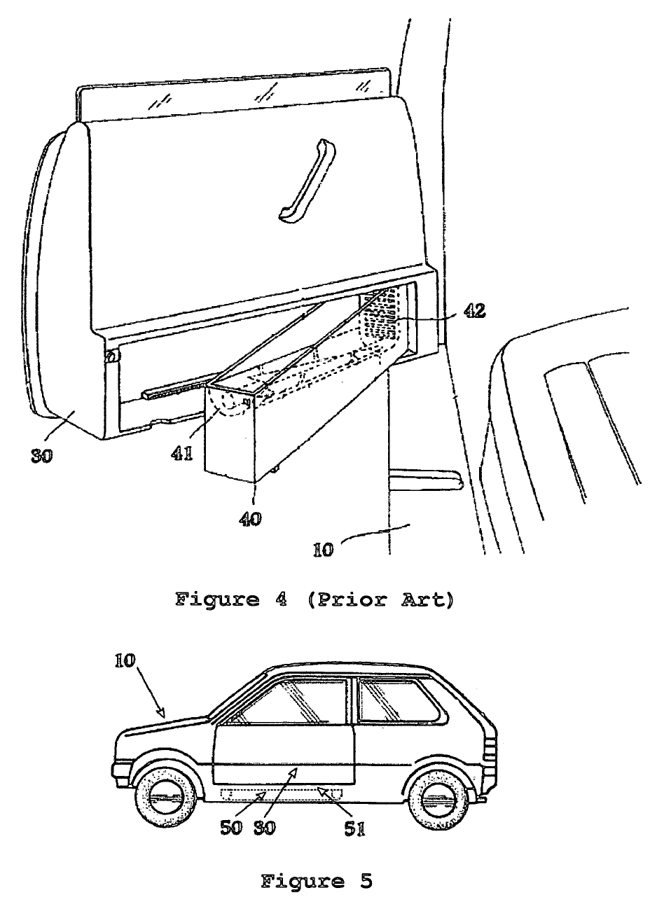

### DETAILED DESCRIPTION

The present invention will be understood more fully from the detailed description given below and from the accompanying drawings of the preferred embodiment of the invention, which, however, should not be taken to limit the invention to the specific embodiment but are for explanation and understanding only.

One embodiment of the present invention is illustrated in FIG. 5. It consists of a compartment 50 in the doorframe 51 of the door 30 of an automobile 10 that is large enough to hold an umbrella. After entering the automobile 10, the user inserts an umbrella into compartment 50 in doorframe 51, then closes door 30.

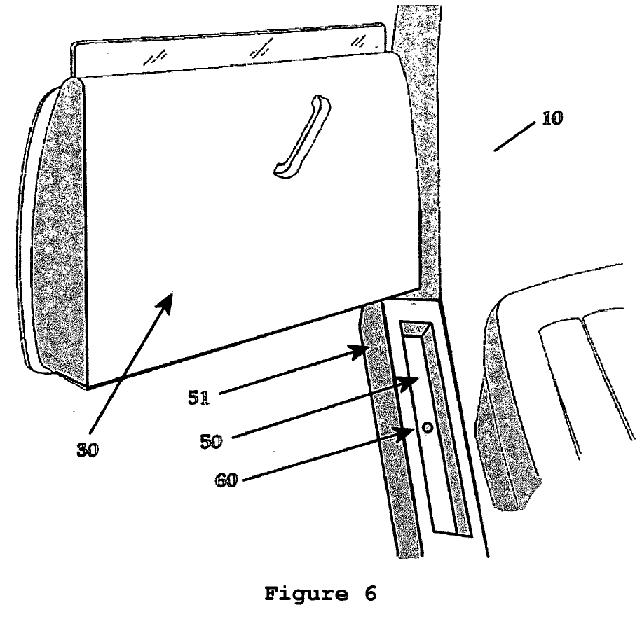

This embodiment is further illustrated in FIG. 6, showing compartment 50 in doorframe 51. Note that the hole 60 in the bottom of the compartment 50 allows water from the stored umbrella to drain out of the automobile 10.

The advantages of this invention are numerous. The passenger does not need to twist or turn uncomfortably to store the umbrella. The water from the umbrella does not get into the automobile and thus cannot damage the passenger's clothes, the automobile carpeting, or the automobile chassis. The water from the umbrella does not evaporate into the automobile and thus does not increase the interior humidity or steam up the windows. Such compartments can be placed in each doorframe in the automobile, giving each passenger easy access. In automobiles with more passengers than doors, the compartments can be large enough to hold more than one umbrella.

Because there are typically no electrical or mechanical components in the doorframe, manufacturing this invention consists only of changing the automobile chassis at the doorframe to include the compartment and the drainage hole.

In another embodiment, a small sliding door over the compartment can be closed to hide the umbrella and keep it from coming out of the compartment. Closing the sliding door can be done manually by the passenger or automatically when the automobile door is closed in order to isolate the umbrella and keep the water vapor from entering the automobile.

Various modifications and adaptations of the apparatus that is described here would be apparent to those skilled in the art based on the above disclosure. Many variations and modifications within the scope of the invention are therefore possible. The present invention is set forth by the following claims.

I claim:

1) An apparatus for storing an umbrella in an automobile comprising
a) a compartment in the doorframe of said automobile to hold said umbrella.

2) The apparatus of claim 1) including
a) an opening in said compartment to allow water to drain to the outside of said automobile.

3) The apparatus of claim 1) including
a) a door to cover said compartment that can be opened and closed.
